(19) United States
(12) Patent Application Publication
(10) Pub. No.: US 2026/0017832 A1
(43) Pub. Date: Jan. 15, 2026

(54) APPARATUS, A METHOD AND A COMPUTER PROGRAM FOR VOLUMETRIC VIDEO

(71) Applicant: Nokia Technologies Oy, Espoo (FI)

(72) Inventors: Lukasz KONDRAD, Munich (DE); Lauri Aleksi ILOLA, Tampere (FI); Patrice RONDAO ALFACE, Antwerp (BE)

(21) Appl. No.: 19/258,079

(22) Filed: Jul. 2, 2025

(30) Foreign Application Priority Data
Jul. 10, 2024 (FI) 20245875

(51) Int. Cl. G06T 9/00; H04N 19/70

(52) U.S. Cl. CPC G06T 9/001; H04N 19/70

(57) ABSTRACT

A method comprising: obtaining at least one mesh frame; analyzing said at least one mesh frame to determine which types of attributes are available as per vertex attributes or per face attributes; generating a simplified version of said at least one mesh frame; packing the determined attributes into at least one patch of one or two attribute video frames based on the attribute type, wherein the attribute type is a per vertex attribute or a per face attribute; and providing one or more signaling elements in a bitstream to indicate an attribute packing method and the attribute type into a video frame.

### TECHNICAL FIELD

The present invention relates to an apparatus, a method and a computer program for volumetric video coding.

### BACKGROUND

Visual volumetric video-based coding (V3C; defined in ISO/IEC DIS 23090-5) provides a generic syntax and mechanism for volumetric video coding. The generic syntax can be used by applications targeting volumetric content, such as point clouds, immersive video with depth, and mesh representations of volumetric frames.

Video-based dynamic mesh coding (V-DMC; ISO/IEC 23090-29) is an application form of V3C that aims on integration of mesh compression into the V3C family of standards. The technology is based on multiresolution mesh analysis and coding. Therein, an original mesh is compressed by generating a base-mesh that is a simplified mesh approximation of the original mesh. An attribute map of the original mesh is transferred to the base mesh at the highest resolution such that texture coordinates (a.k.a. UV coordinates) are obtained for the base mesh and a new attribute map is generated. The original mesh may have attributes that provide information for the whole mesh, but also attributes that are applicable only to a vertex.

In the V-DMC, it is implicitly assumed that an attribute map will be created for per vertex attributes, as well as for the per face attributes, and the attribute map will be accessed using UV coordinates that are provided by base mesh and updated during the subdivision process on the decoder. This leads to attribute maps, which contain a lot of data between the UV-mapped vertices.

However, such attribute map together with the UV coordinates increases the redundancy in the amount of data stored in per vertex attributes, because a large amount of data in the attribute map will be unused and discarded.

### SUMMARY

Now, an improved method and technical equipment implementing the method has been invented, by which the above problems are alleviated. Various aspects include a method, an apparatus and a computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for obtaining at least one mesh frame; means for analyzing said at least one mesh frame to determine which types of attributes are available as per vertex attributes or per face attributes; means for generating a simplified version of said at least one mesh frame; means for packing the determined attributes into at least one patch of one or two attribute video frames based on the attribute type, wherein the attribute type is a per vertex attribute or a per face attribute; and means for providing one or more signaling elements in a bitstream to indicate an attribute packing method and the attribute type into a video frame.

According to an embodiment, the apparatus comprises means for providing at least one signaling element in the bitstream to assist extraction process from the video frame.

According to an embodiment, the packing of the per vertex attributes to an attribute video frame is carried out in the same order and patch position as per vertex displacement information in a displacement video frame.

According to an embodiment, the apparatus comprises means for splitting said at least one patch of the attribute video frame into multiple patches based on level-of-details (LoD) of the per vertex attributes.

According to an embodiment, the packing of the per vertex attributes to an attribute video frame is carried out in the same order as per vertex displacement information in a displacement video frame, but in different patch position from a patch position in the displacement video frame.

According to an embodiment, a level-of-details (LoD) of the attribute video frame is different from the LoD in displacement video frame.

According to an embodiment, said one or more signaling elements in the bitstream provide a mapping of V3C attribute index to an attribute packing method.

According to an embodiment, the attribute packing method is based on UV coordinates, wherein said one or more signaling elements in the bitstream provide a mapping of the per face attributes to an attribute index of the simplified version of said at least one mesh frame.

According to an embodiment, the attribute packing method is based on UV coordinates, wherein said one or more signaling elements in the bitstream provide a mapping of the per face attributes to patches in atlas.

According to an embodiment, said one or more signaling elements in the bitstream provide an indication that the attribute packing method is index-based. According to a second aspect, there is provided an apparatus comprising at least one processor and at least one memory, said at least one memory stored with computer program code thereon, the at least one memory and the computer program code configured to, with the at least one processor, cause the apparatus at least to perform: obtain at least one mesh frame; analyze said at least one mesh frame to determine which types of attributes are available as per vertex attributes or per face attributes; generate a simplified version of said at least one mesh frame; pack the determined attributes into at least one patch of one or two attribute video frames based on the attribute type, wherein the attribute type is a per vertex attribute or a per face attribute; and provide one or more signaling elements in a bitstream to indicate an attribute packing method and the attribute type into a video frame.

A methos according to a third aspect comprises obtaining at least one mesh frame; analyzing said at least one mesh frame to determine which types of attributes are available as per vertex attributes or per face attributes; generating a simplified version of said at least one mesh frame; packing the determined attributes into at least one patch of one or two attribute video frames based on the attribute type, wherein the attribute type is a per vertex attribute or a per face attribute; and providing one or more signaling elements in a bitstream to indicate an attribute packing method and the attribute type into a video frame.

An apparatus according to a fourth aspect comprises means for obtaining a bitstream comprising a plurality of compressed sub-bitstreams including at least a base mesh sub-bitstream comprising a base mesh and an attribute sub-bitstream comprising one or two attribute video frames; means for obtaining one or more signaling elements in the bitstream indicating an attribute packing method and the attribute type applied for attributes of the one or two attribute video frames, wherein the attribute type is a per vertex attribute or a per face attribute; means for unpacking the determined attributes from at least one patch of the one or two attribute video frames; and means for initializing a subdivision process of the base mesh to generate an original mesh underlying the base mesh at least partly based on the attributes.

According to an embodiment, the apparatus comprises means for initializing a subdivision process of the base mesh to generate a lookup table comprising a triangle index in the base mesh and edge indices of the corresponding triangle to an edge index in the base mesh; means for obtaining an integer number of edges in the base mesh; means for processing the base mesh per triangle; and means for determining an attribute index value per vertex; and means for converting the attribute index value to a coordinate position in the corresponding attribute video frame.

An apparatus according to a fifth aspect comprises at least one processor and at least one memory, said at least one memory stored with computer program code thereon, the at least one memory and the computer program code configured to, with the at least one processor, cause the apparatus at least to perform: obtain a bitstream comprising a plurality of compressed sub-bitstreams including at least a base mesh sub-bitstream comprising a base mesh and an attribute sub-bitstream comprising one or two attribute video frames; obtain one or more signaling elements in the bitstream indicating an attribute packing method and the attribute type applied for attributes of the one or two attribute video frames, wherein the attribute type is a per vertex attribute or a per face attribute; unpack the determined attributes from at least one patch of the one or two attribute video frames; and initialize a subdivision process of the base mesh to generate an original mesh underlying the base mesh at least partly based on the attributes.

According to a sixth aspect, there is provided a method comprising: obtaining a bitstream comprising a plurality of compressed sub-bitstreams including at least a base mesh sub-bitstream comprising a base mesh and an attribute sub-bitstream comprising one or two attribute video frames; obtaining one or more signaling elements in the bitstream indicating an attribute packing method and the attribute type applied for attributes of the one or two attribute video frames, wherein the attribute type is a per vertex attribute or a per face attribute; unpacking the determined attributes from at least one patch of the one or two attribute video frames; and initializing a subdivision process of the base mesh to generate an original mesh underlying the base mesh at least partly based on the attributes.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIGS. 1a and 1b show an encoder and decoder for encoding and decoding 2D pictures;

FIGS. 2a and 2b show a compression and a decompression process for 3D volumetric video;

FIG. 3 shows a plurality of compressed sub-bitstreams generated by a V-DMC encoder;

FIG. 4 shows a general structure of the compressed bitstream generated by a Draco encoder;

FIG. 5 shows an example of packing displacement vectors into regions corresponding to the subdivision level;

FIG. 6 shows a flow chart for an encoding method according to a first aspect;

FIG. 7 shows an example of an attribute video frame having a patch comprising attribute information per vertex positioned according to an embodiment;

FIG. 8 shows an example of an attribute video frame having a patch comprising attribute information per vertex positioned according to another embodiment;

FIG. 9 shows an example of an attribute video frame having a patch comprising attribute information per vertex positioned according to yet another embodiment;

FIG. 10 shows a flow chart for a decoding method according to the first aspect;

FIG. 11 shows a flow chart for a decoding method according to a second aspect;

FIG. 12 shows an example of a base mesh triangle subdivided three times; and

FIG. 13 shows an example of a base mesh triangle subdivided twice.

### DETAILED DESCRIPTION OF SOME EXAMPLE EMBODIMENTS

A video codec comprises an encoder that transforms the input video into a compressed representation suited for storage/transmission, and a decoder that can un-compress the compressed video representation back into a viewable form. An encoder may discard some information in the original video sequence in order to represent the video in a more compact form (i.e. at lower bitrate).

Volumetric video may be captured using one or more three-dimensional (3D) cameras. When multiple cameras are in use, the captured footage is synchronized so that the cameras provide different viewpoints to the same world. In contrast to traditional 2D/3D video, volumetric video describes a 3D model of the world where the viewer is free to move and observer different parts of the world.

Volumetric video enables the viewer to move in six degrees of freedom (6DOF): in contrast to common 360° video, where the user has from 2 to 3 degrees of freedom (yaw, pitch, and possibly roll), a volumetric video represents a 3D volume of space rather than a flat image plane. Volumetric video frames contain a large amount of data because they model the contents of a 3D volume instead of just a two-dimensional (2D) plane. However, only a relatively small part of the volume changes over time. Therefore, it may be possible to reduce the total amount of data by only coding information about an initial state and changes which may occur between frames. Volumetric video can be rendered from synthetic 3D animations, reconstructed from multi-view video using 3D reconstruction techniques such as structure from motion, or captured with a combination of cameras and depth sensors such as LiDAR (Light Detection and Ranging), for example.

Volumetric video data represents a three-dimensional scene or object, and thus such data can be viewed from any viewpoint. Volumetric video data can be used as an input for augmented reality (AR), virtual reality (VR) and mixed reality (MR) applications. Such data describes geometry (shape, size, position in 3D-space) and respective attributes (e.g. color, opacity, reflectance, . . . ), together with any possible temporal changes of the geometry and attributes at given time instances (e.g. frames in 2D video). Volumetric video is either generated from 3D models, i.e. computer-generated imagery (CGI), or captured from real-world scenes using a variety of capture solutions, e.g. a multi-camera, a laser scan, a combination of video and dedicated depths sensors, etc. Also, a combination of CGI and real-world data is possible. Examples of representation formats for such volumetric data are triangle meshes, point clouds, or voxel. Temporal information about the scene can be included in the form of individual capture instances, i.e. “frames” in 2D video, or other means, e.g. position of an object as a function of time.

Increasing computational resources and advances in 3D data acquisition devices has enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications, such as capturing real world 3D scenes where the topology is not necessarily a 2D manifold. Another way to represent 3D data is coding this 3D data as a set of texture and depth map as is the case in the multi-view plus depth. Closely related to the techniques used in multi-view plus depth is the use of elevation maps, and multi-level surface maps.

In 3D point clouds, each point of each 3D surface is described as a 3D point with color and/or other attribute information such as surface normal or material reflectance. Point cloud is a set of data points in a coordinate system, for example in a three-dimensional coordinate system being defined by X, Y, and Z coordinates. The points may represent an external surface of an object in the screen space, e.g. in a three-dimensional space.

In dense point clouds or voxel arrays, the reconstructed 3D scene may contain tens or even hundreds of millions of points. If such representations are to be stored or interchanged between entities, then efficient compression of the presentations becomes fundamental. Standard volumetric video representation formats, such as point clouds, meshes, voxel, suffer from poor temporal compression performance. Identifying correspondences for motion-compensation in 3D-space is an ill-defined problem, as both, geometry and respective attributes may change. For example, temporal successive “frames” do not necessarily have the same number of meshes, points or voxel. Therefore, compression of dynamic 3D scenes is inefficient. 2D-video based approaches for compressing volumetric data, i.e. multiview with depth, have much better compression efficiency, but rarely cover the full scene. Therefore, they provide only limited 6DOF capabilities.

Instead of the above-mentioned approach, a 3D scene, represented as meshes, points, and/or voxel, can be projected onto one, or more, geometries. These geometries may be “unfolded” or packed onto 2D planes (two planes per geometry: one for texture, one for depth), which are then encoded using standard 2D video compression technologies. Relevant projection geometry information may be transmitted alongside the encoded video files to the decoder. The decoder decodes the video and performs the inverse projection to regenerate the 3D scene in any desired representation format (not necessarily the starting format).

Projecting volumetric models onto 2D planes allows for using standard 2D video coding tools with highly efficient temporal compression. Thus, coding efficiency can be increased greatly. Using geometry-projections instead of 2D-video based approaches based on multiview and depth, provides a better coverage of the scene (or object). Thus, 6DOF capabilities are improved. Using several geometries for individual objects improves the coverage of the scene further. Furthermore, standard video encoding hardware can be utilized for real-time compression/decompression of the projected planes. The projection and the reverse projection steps are of low complexity.

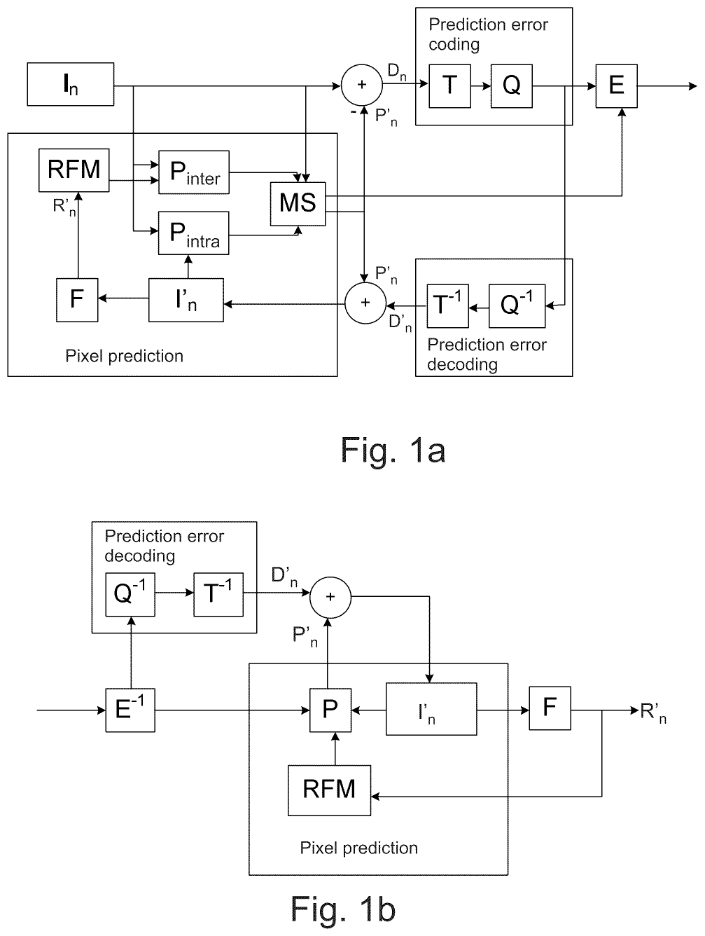

FIGS. 1a and 1b show an encoder and decoder for encoding and decoding the 2D texture pictures, geometry pictures and/or auxiliary pictures. A video codec consists of an encoder that transforms an input video into a compressed representation suited for storage/transmission and a decoder that can uncompress the compressed video representation back into a viewable form. Typically, the encoder discards and/or loses some information in the original video sequence in order to represent the video in a more compact form (that is, at lower bitrate). An example of an encoding process is illustrated in FIG. 1a. FIG. 1a illustrates an image to be encoded (Iⁿ); a predicted representation of an image block (P′ⁿ); a prediction error signal (Dⁿ); a reconstructed prediction error signal (D′ⁿ); a preliminary reconstructed image (I′ⁿ); a final reconstructed image (R′ⁿ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F).

An example of a decoding process is illustrated in FIG. 1b. FIG. 1b illustrates a predicted representation of an image block (P′ⁿ); a reconstructed prediction error signal (D′ⁿ); a preliminary reconstructed image (I′ⁿ); a final reconstructed image (R′ⁿ); an inverse transform (T⁻¹); an inverse quantization (Q⁻¹); an entropy decoding (E⁻¹); a reference frame memory (RFM); a prediction (either inter or intra) (P); and filtering (F).

Many hybrid video encoders encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate). Video codecs may also provide a transform skip mode, which the encoders may choose to use. In the transform skip mode, the prediction error is coded in a sample domain, for example by deriving a sample-wise difference value relative to certain adjacent samples and coding the sample-wise difference value with an entropy coder.

Many video encoders partition a picture into blocks along a block grid. For example, in the High Efficiency Video Coding (HEVC) standard, the following partitioning and definitions are used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as LCU (largest coding unit) or coding tree unit (CTU) and the video picture is divided into non-overlapping LCUs.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

Entropy coding/decoding may be performed in many ways. For example, context-based coding/decoding may be applied, where in both the encoder and the decoder modify the context state of a coding parameter based on previously coded/decoded coding parameters. Context-based coding may for example be context adaptive binary arithmetic coding (CABAC) or context-adaptive variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

The phrase along the bitstream (e.g. indicating along the bitstream) may be defined to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream. For example, an indication along the bitstream may refer to metadata in a container file that encapsulates the bitstream.

A first texture picture may be encoded into a bitstream, and the first texture picture may comprise a first projection of texture data of a first source volume of a scene model onto a first projection surface. The scene model may comprise a number of further source volumes.

In the projection, data on the position of the originating geometry primitive may also be determined, and based on this determination, a geometry picture may be formed. This may happen for example so that depth data is determined for each or some of the texture pixels of the texture picture. Depth data is formed such that the distance from the originating geometry primitive such as a point to the projection surface is determined for the pixels. Such depth data may be represented as a depth picture, and similarly to the texture picture, such geometry picture (such as a depth picture) may be encoded and decoded with a video codec. This first geometry picture may be seen to represent a mapping of the first projection surface to the first source volume, and the decoder may use this information to determine the location of geometry primitives in the model to be reconstructed. In order to determine the position of the first source volume and/or the first projection surface and/or the first projection in the scene model, there may be first geometry information encoded into or along the bitstream. It is noted that encoding a geometry (or depth) picture into or along the bitstream with the texture picture is only optional and arbitrary for example in the cases where the distance of all texture pixels to the projection surface is the same or there is no change in said distance between a plurality of texture pictures. Thus, a geometry (or depth) picture may be encoded into or along the bitstream with the texture picture, for example, only when there is a change in the distance of texture pixels to the projection surface.

An attribute picture may be defined as a picture that comprises additional information related to an associated texture picture. An attribute picture may for example comprise surface normal, opacity, or reflectance information for a texture picture. A geometry picture may be regarded as one type of an attribute picture, although a geometry picture may be treated as its own picture type, separate from an attribute picture.

Texture picture(s) and the respective geometry picture(s), if any, and the respective attribute picture(s) may have the same or different chroma format.

Terms texture (component) image and texture (component) picture may be used interchangeably. Terms geometry (component) image and geometry (component) picture may be used interchangeably. A specific type of a geometry image is a depth image. Embodiments described in relation to a geometry (component) image equally apply to a depth (component) image, and embodiments described in relation to a depth (component) image equally apply to a geometry (component) image. Terms attribute image and attribute picture may be used interchangeably. A geometry picture and/or an attribute picture may be treated as an auxiliary picture in video/image encoding and/or decoding.

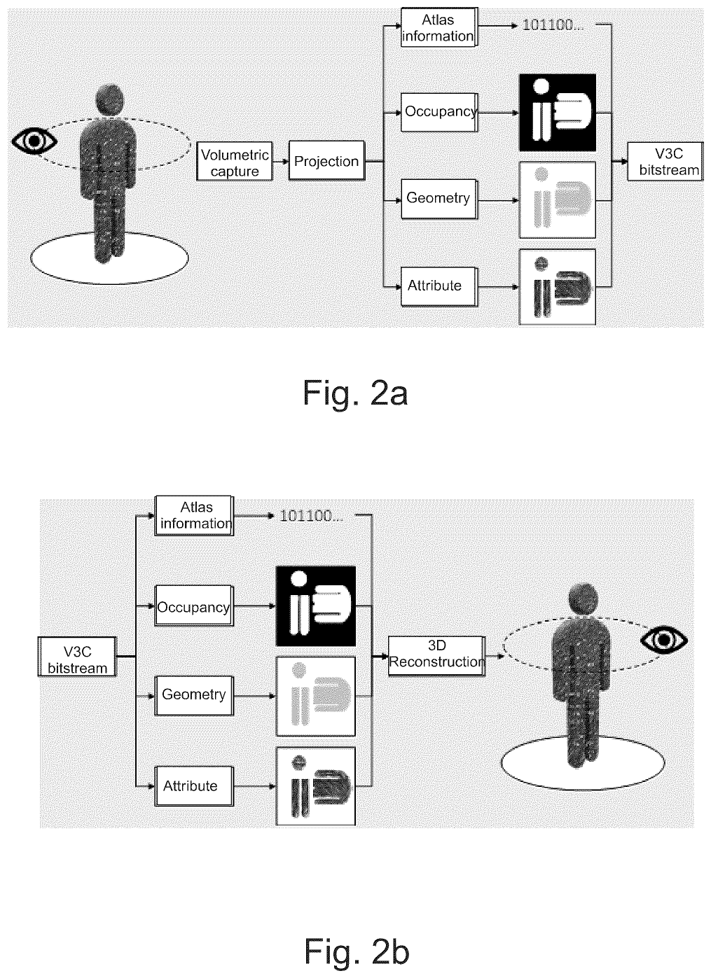

FIGS. 2a and 2b illustrate an overview of exemplified compression/decompression processes. The processes may be applied, for example, in MPEG visual volumetric video-based coding (V3C), defined currently in ISO/IEC DIS 23090-5: “Visual Volumetric Video-based Coding and Video-based Point Cloud Compression”.

V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example of volumetric media conversion at an encoder is shown in FIG. 2a and an example of a 3D reconstruction at a decoder is shown in FIG. 2b.

There are alternatives to capture and represent a volumetric frame. The format used to capture and represent the volumetric frame depends on the process to be performed on it, and the target application using the volumetric frame. As a first example a volumetric frame can be represented as a point cloud. A point cloud is a set of unstructured points in 3D space, where each point is characterized by its position in a 3D coordinate system (e.g., Euclidean), and some corresponding attributes (e.g., color information provided as RGBA value, or normal vectors). As a second example, a volumetric frame can be represented as images, with or without depth, captured from multiple viewpoints in 3D space. In other words, the volumetric video can be represented by one or more view frames (where a view is a projection of a volumetric scene on to a plane (the camera plane) using a real or virtual camera with known/computed extrinsic and intrinsic). Each view may be represented by a number of components (e.g., geometry, color, transparency, and occupancy picture), which may be part of the geometry picture or represented separately. As a third example, a volumetric frame can be represented as a mesh. Mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e., both translational and rotational movement of their viewing pose (which includes yaw, pitch, and roll). The data to be coded for a volumetric frame can also be significant, as a volumetric frame can contain many numbers of objects, and the positioning and movement of these objects in the scene can result in many dis-occluded regions. Furthermore, the interaction of the light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

Visual Volumetric Video-based Coding (V3C), defined in ISO/IEC 23090-5, specifies the syntax, semantics, and process for coding volumetric video. The specified syntax is designed to be generic, so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, Video-based Point Cloud Compression (V-PCC; ISO/IEC 23090-5) and MPEG Immersive Video (MIV) (ISO/IEC 23090-12). MIV and V-PCC use number of V3C syntax elements with a slightly modified semantics.

V3C bitstream is a sequence of bits that forms the representation of coded volumetric frames and the associated data making one or more coded V3C sequences (CVS). CVS is a sequence of bits identified and separated by appropriate delimiters, required to start with a V3C Parameter Set (VPS). CVS includes a V3C unit, and contains one or more V3C units with atlas sub-bitstream, base-mesh sub-bitstream, or video sub-bitstream. Video sub-bitstreams, base-mesh sub-bitstream, and atlas sub-bitstreams can be referred to as V3C sub-bitstreams. A V3C unit header in conjunction with VPS information identifies which V3C sub-bitstream the V3C unit contains and how to interpret it.

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

Video-based dynamic mesh coding (V-DMC; ISO/IEC 23090-29) is another application form of V3C that aims on integration of mesh compression into the V3C family of standards. The technology is based on multiresolution mesh analysis and coding. This approach involves:
generating a base mesh that is a simplified (low resolution) mesh approximation of the original mesh. This is carried out for all frames of the dynamic mesh sequence.
performing several mesh subdivision iterative steps (e.g., each triangle is converted into four triangles by connecting the triangle edge midpoints on the generated base mesh, generating other approximation meshes)
defining displacement vectors, also referred to as error vectors, for each vertex of each mesh approximation. Each approximation can be seen as level of details (LoD) of the original mesh.
generating the best approximation of the original mesh for each subdivision level by adding the displacement vectors to the subdivided mesh vertices at that resolution, based on the base mesh and prior subdivision levels.
the displacement vectors may undergo a lazy wavelet transform prior to compression.
the attribute map of the original mesh is transferred to the deformed (i.e. base) mesh at the highest resolution (i.e., subdivision level) such that texture coordinates are obtained for the deformed mesh and a new attribute map is generated.

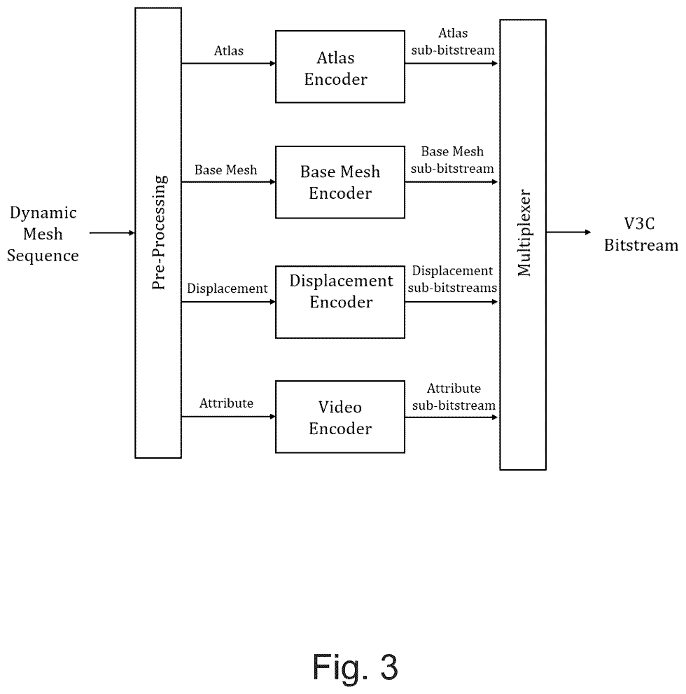

The V-DMC encoder generates a plurality of compressed sub-bitstreams, as illustrated in FIG. 3, which are packed in V3C units and a V3C bitstream is created by concatenating V3C units. The sub-bitstreams comprise:
A base mesh sub-bitstream, comprising the base-mesh encoded by a mesh codec;
Displacement sub-bitstream(s) comprising the displacement vectors:
   packed in an 2D frame and encoded using a video codec or image codec, or
   arithmetic encoded as defined in Annex J of WD ISO/IEC 23090-29;
An attribute sub-bitstream comprising the attribute map encoded using a video codec;
An atlas sub-bitstream comprising all metadata required to decode and reconstruct the mesh sequence based on the aforementioned sub-bitstreams. The signaling of the metadata is based on the V3C syntax and includes necessary extensions that are specific to meshes.

A base-mesh sub-bitstream may be generated by any mesh codec. One form of such encoder is specified in Annex H of ISO/IEC 23090-29. Annex H of ISO/IEC specifies a generic bitstream format with intra and inter frames. The codecs used for intra and inter coding can by any existing codec for static mesh. After encoding, the encoded data is encapsulated in network abstraction (NAL) units. A NAL unit is defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

In Annex H of ISO/IEC 23090-29 NAL units are categorized into Base-mesh Coding Layer (BMCL) NAL units and non-BMCL NAL units. BMCL NAL units can be coded sub-mesh NAL units. A non-BMCL NAL unit may be, for example, one of the following types: a base-mesh sequence parameter set, a base-mesh frame parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded bas-mesh, whereas many of the other non-BMCL NAL units are not necessary for the reconstruction of decoded sample values.

The MPEG EdgeBreaker, defined in ISO/IEC 23090-29: Annex I, is a static mesh codec specifying signalling and decoding processes for intra mesh coding based on the well-known EdgeBreaker algorithm, which was extended with several algorithmic enhancements allowing to handle a wider variety of mesh connectivity types and better geometry and UV texture coordinate predictions. It achieves comparable compression performances as the Draco compression.

ISO/IEC 23090-29: Annex I specify the general mesh coding syntax by a mesh coding header, a mesh position coding payload and mesh attributes coding payload.

TABLE 1
General Mesh coding syntax

Descriptor

```
mesh_coding( ) {
  mesh_coding_header( )
  mesh_position_coding_payload( )
  mesh_attributes_coding_payload( )
}
```

The mesh coding header syntax is shown in Table 2 below and includes the mesh codec type (i.e. the chosen mesh connectivity traversal), position encoding parameters, position dequantization information, the number of mesh attributes and the number of components for each mesh attributes (2 for texture coordinates, 3 for normal and colors, 1 for material type and a generic type with n components), and attribute coding and dequantization parameters.

TABLE 2
Mesh coding header syntax.

| | Descriptor |
|---|---|
| mesh_coding_header( ) { | |
| mesh_codec_type | u(2) |
| mesh_position_encoding_parameters( ) | |
| mesh_position_dequantize_flag | u(1) |
| if (mesh_position_dequantize_flag ) | |
| mesh_position_dequantize_parameters( ) | |
| mesh_attribute_count | u(5) |
| for( i=0; i<mesh_attribute_count; i++ ){ | |
| mesh_attribute_type[ i ] | u(3) |
| if( mesh_attribute_type[ i ] == MESH_ATTR_TEXCOORD ) | |
| NumComponents[ i ] = 2 | |
| else if( mesh_attribute_type[ i ] == MESH_ATTR_NORMAL ) | |
| NumComponents[ i ] = 3 | |
| else if( mesh_attribute_type[ i ] == MESH_ATTR_COLOR ) | |
| NumComponents[ i ] = 3 | |
| else if( mesh_attribute_type[ i ] == MATERIAL_ID ) | |
| NumComponents[ i ] = 1 | |
| else if( mesh_attribute_type[ i ] == GENERIC ) { | |
| mesh_attribute_num_components_minus1[ i ] | u(2) |
| NumComponents[ i ] = mesh_attribute_num_components_min | |
| us1[ i ]+1 | |
| } | |
| mesh_attribute_encoding_parameters ( i ) | |
| mesh_attribute_dequantize_flag[ i ] | u(1) |
| if (mesh_attribute_dequantize_flag[ i ] ) | |
| mesh_attribute_dequantize_parameters ( i ) | |
| } | |
| length_alignment( ) | |
| } | |

The position coding parameters are specified as shown in Table 3. The position coding parameters include information related to the position bitdepth, the chosen EdgeBreaker CLERS symbols coding method, the used position prediction methods, the chosen position residuals encoding method and finally the position duplicate removal method.

TABLE 3
Mesh position encoding parameters syntax.

| | Descriptor |
|---|---|
| mesh_position_encoding_parameters( ) { | |
| mesh_position_bit_depth_minus1 | u(4) |
| mesh_clers_symbols_encoding_method | ue(v) |
| mesh_position_prediction_method | ue(v) |
| mesh_position_prediction_max_parallelograms_minus1 | u(4) |
| mesh_position_residuals_encoding_method | ue(v) |
| mesh_position_deduplicate_method | ue(v) |
| } | |

The mesh attributes encoding parameters are provided per attribute (signalled by its index) according to Table 4. The mesh attributes encoding parameters signal the attribute bitdepth, whether it relates to a per face attribute and in such case, if a separate index table is provided for the attributes. Herein, several attributes may be mapped to the same face, whereupon it is suitable to provide a separate index table with a mapping between attribute value index and face index. The mesh attributes encoding parameters also indicate the used mesh attribute prediction method and the mesh attribute residuals encoding method.

TABLE 4
Mesh attributes encoding parameters syntax.

| | Descriptor |
|---|---|
| mesh_attribute_encoding_parameters( index ) { | |
| mesh_attribute_bit_depth_minus1[ index ] | u(4) |
| mesh_attribute_per_face_flag[ index ] | u(1) |
| if( !mesh_attribute_per_face_flag[ index ] ) { | |
| mesh_attribute_separate_index_flag[ index ] | u(1) |
| if( !mesh_attribute_separate_index_flag[ index ] ) | |
| mesh_attribute_reference_index_plus1[ index ] | ue(v) |
| } | |
| mesh_attribute_prediction_method[ index ] | ue(v) |
| mesh_attribute_residuals_encoding_method[ index ] | ue(v) |
| } | |

Draco is a technology for compressing and decompressing 3D geometric meshes and point clouds. It is intended to improve the storage and transmission of 3D graphics. It supports compressing points, connectivity information, texture coordinates, color information, normals, and any other generic attributes associated with geometry. Draco may compress the 3D mesh either sequentially or using edgebreaker algorithm. The input to Draco encoder can be any 3D model and the encoder compresses it into a Draco bitstream. The compressed bitstream may be decoded back into the original 3D model, or transcoded into a different format, if needed.

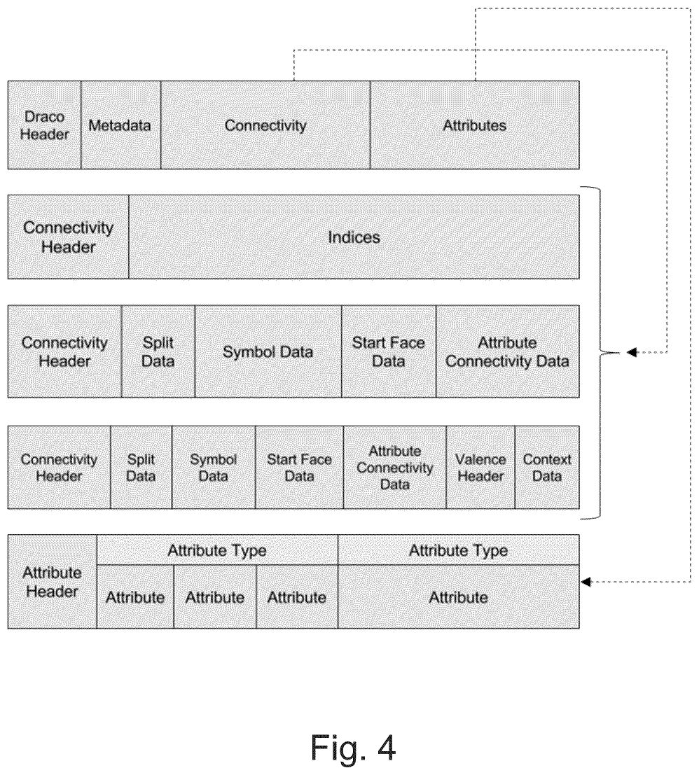

The compressed bitstream is divided into four parts: Draco header, metadata, connectivity and attributes. The general structure of the compressed bitstream is illustrated in FIG. 4, where three different alternative structures for the connectivity data have been separated.

The Draco header contains high-level information about the bitstream and identifies the bitstream as Draco bitstream. The metadata part allows to associate per attribute metadata or file level metadata with the Draco bitstream. It could be used e.g. to describe attribute names. The metadata enables recursively adding more levels of sub-metadata. The metadata is represented by key-value pairs.

The structure of the connectivity part depends on the encoder method. It consists of either sequential or edgebreaker information. The type of connectivity information is defined in the Draco header (encoder_method). The sequential connectivity header contains information, such as the number of faces and points in the connectivity bitstream, as well as the connectivity method, which identifies if the sequential connectivity bitstream consists of compressed indices or uncompressed indices. The rest of the connectivity data contains the connectivity bitstream.

Alternatively, the compressed Draco bitstream may consist of edgebreaker encoded connectivity data instead of the sequential connectivity data. In this case the connectivity header contains information as defined by ParseEdgebreakerConnectivityData structure, wherein the header provides information such as the traversal type, which indicates the type of the edgebreaker connectivity bitstream. In current version, this can be either standard edgebreaker (0) or valence edgebreaker (2). The header also provides further information, such as the number of encoded vertices and attributes. It also provides information on the number of encoder symbols and split symbols, which are required to decode different parts of the edgebreaker encoded connectivity bitstream. In addition to the connectivity header, the connectivity data contains the connectivity bitstream.

The structure of the connectivity bitstream depends on the traversal type and can include encoded split data, encoded edgebreaker symbol data, encoded start face configuration data and the attribute connectivity data. It may additionally include valence header and context data in case edgebreaker valence traversal type is used.

The attribute data contains two sections. The first part is the attribute header, which indicates how many attributes need to be decoded, as well as what components each attribute comprises. The second part of the attribute data comprises compressed attributes, such as positions, texture coordinates, normals, etc. Each attribute type section comprises one or more unique components.

Referring back to the V-DMC encoder and the plurality of compressed sub-bitstreams disclosed in FIG. 3, the input mesh is simplified into a base-mesh. This is done by performing several mesh subdivision iterative steps (e.g., each triangle is converted into four triangles by connecting the triangle edge midpoints on the generated base mesh, generating other approximation meshes). Following this, displacement vectors, also referred to as error vectors, for each vertex of each mesh approximation are computed. Each approximation can be seen as level of details (LoD) of the original mesh. By adding the displacement vectors to the subdivided mesh vertices generates the best approximation of the original mesh at that resolution, given the base-mesh and prior subdivision levels.

Displacement vectors are packed in a 2D frame and encoded using a video codec or image codec. The packing and unpacking of the displacement vectors from the 2D frame are defined more precisely in V-DMC: ISO/IEC 23090-29, chap. 11.2.4 “Inverse image packing of transform coefficients”.

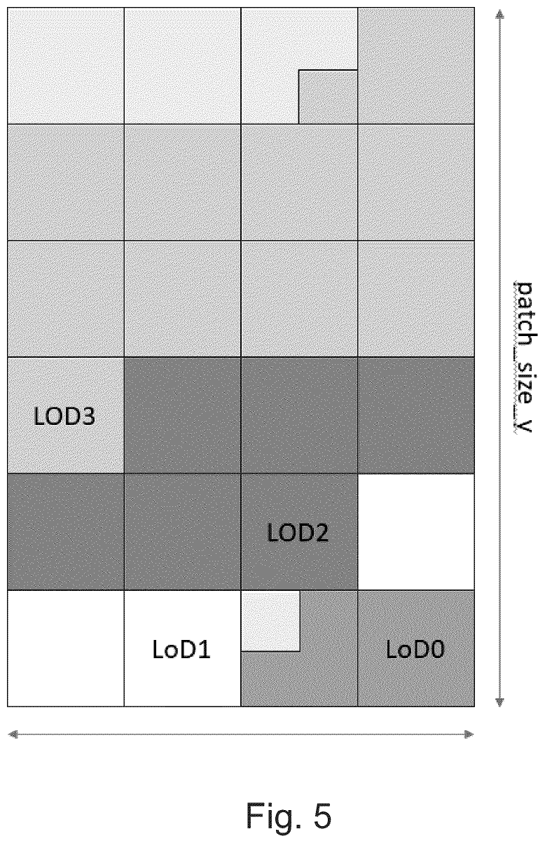

Displacement vectors for each vertex are separated to distinctive regions corresponding to the subdivision level, as shown in FIG. 5 illustrating displacement packing to a patch. A patch corresponds to a region in a video frame. Each block corresponds to PatchPackingBlockSize*PatchPackingBlockSize pixels in the video frame. The subdivision levels are represented by the level of details (LoD0, LoD1, LoD2, . . . ) of the original mesh. As shown in FIG. 5, when the LoD increases, the amount of details in the approximations increases, whereupon the number of displacement vectors also increases. This can be seen as the increased number of blocks of the patch used for higher LoDs.

In V-DMC, attribute video frames are accessed by texture coordinates, also called UV coordinates, attached to vertices of the base mesh and interpolated for the subdivided mesh during the reconstruction process. Using texture coordinates, the color properties of a vertex v with texture coordinates (u,v) are defined by the pixel of the Texture Attribute Map A(u,v). As texture coordinates are normalized and quantized in the base mesh sub-bitstream, the color information may relate to an exact pixel position in the texture video frame or a fractional pixel, i.e., a position in between two or four pixels, that is bilinearly interpolated as supported by GPUs.

The V-DMC compresses an original mesh by generating a base-mesh that is a simplified mesh approximation of the original mesh. The attribute map of the original mesh is transferred to the base-mesh at the highest resolution such that texture coordinates are obtained for the base-mesh and a new attribute map is generated. The original mesh may have attributes that provide information for the whole mesh (i.e. for each position of each face of mesh), but also attributes that are applicable only to a vertex (e.g. normal of the vertex). V-DMC specification implicitly assumes that an attribute map will be created for per vertex attributes, as well as for the per face attributes, and the attribute map will be accessed using UV coordinates that are provided by base mesh and updated during the subdivision process on the decoder. This leads to attribute maps, which contain a lot of data between the UV-mapped vertices.

Such attribute map together with the UV coordinates increases the redundancy in the amount of data stored in per vertex attributes, because a large amount of data in the attribute map will be unused and discarded.

In the following, an enhanced method according to a first aspect will be described in more detail, in accordance with various embodiments.

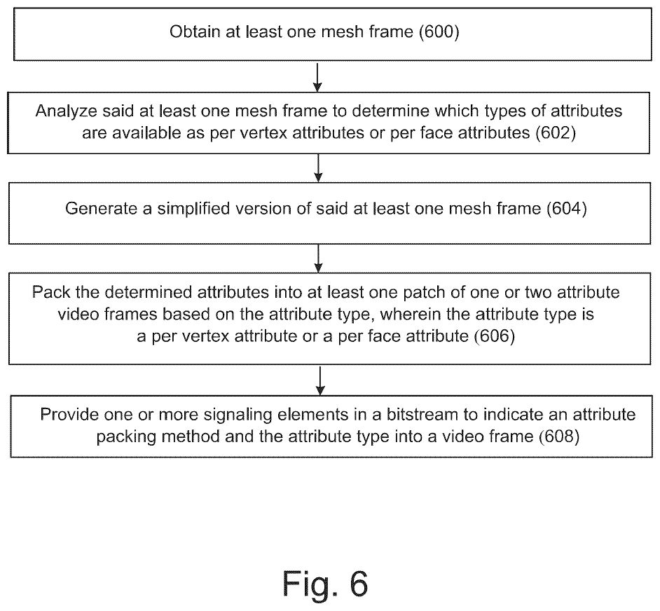

A method according to a first aspect is shown in FIG. 6, where the method comprises obtaining (600) at least one mesh frame; analyzing (602) said at least one mesh frame to determine which types of attributes are available as per vertex attributes or per face attributes; generating (604) a simplified version of said at least one mesh frame; packing (606) the determined attributes into at least one patch of one or two attribute video frames based on the attribute type, wherein the attribute type is a per vertex attribute or a per face attribute; and providing (608) one or more signaling elements in a bitstream to indicate an attribute packing method and the attribute type into a video frame.

Thus, the determined attributes, i.e. per vertex attribute or a per face attribute, are packed into an attribute-specific attribute video frame. If the analysis reveals only either type of attributes, i.e. per vertex attribute or a per face attribute, then only one attribute video frame is used. If both types of attributes, i.e. per vertex attribute and a per face attribute, are determined to be present, then two attribute video frames are used. The packing of the determined attributes, either per vertex attribute or a per face attribute, into at least one patch of the one or two attribute video frames based on the attribute type and providing signaling elements in the bitstream to indicate an attribute packing method and the attribute type into a video frame enables to decrease the redundancy in the amount of data stored in per vertex attributes by skipping a lot of unnecessary data between the UV-mapped vertices. Thereby, the method enables to reduce the dimension of the per vertex attribute video frame, which in turn may reduce the bitrate of the attribute per vertex component.

According to an embodiment, the packing of the per vertex attributes to said at least one patch of the attribute video frame is carried out in the same order and patch position as per vertex displacement information in a displacement video frame.

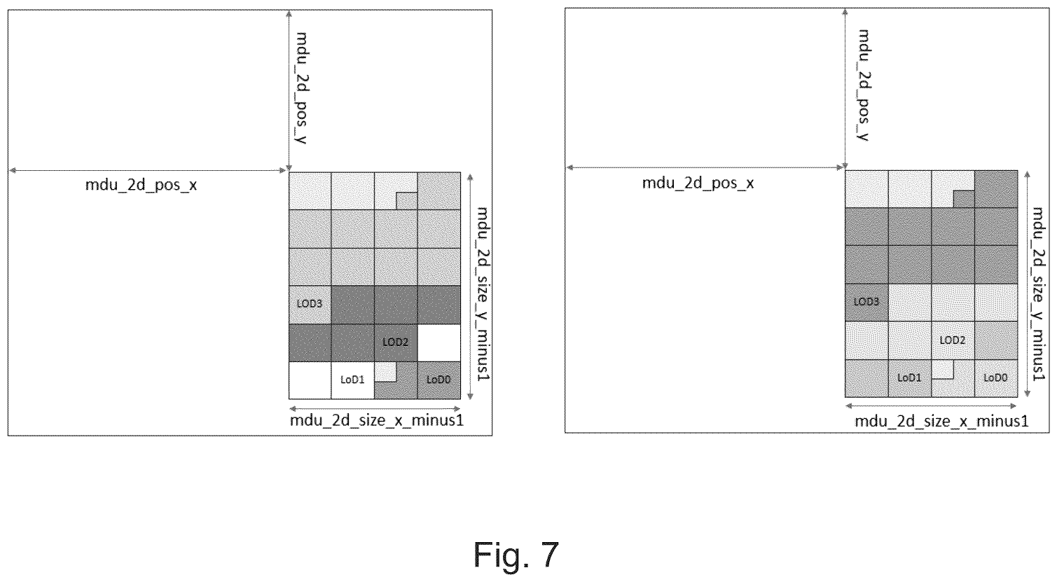

This is illustrated in FIG. 7, where the frame on the left shows a displacement video frame similar to that of FIG. 5, where the pixels of the patch comprise displacement information per vertex. The frame on the right shows an attribute video frame, where the pixels of the patch comprise attribute information per vertex. The size and the location of the patch within the frame and the blocks representing the different LoDs are the same as in the displacement video frame.

According to an embodiment, said at least one patch of the attribute video frame is split into multiple patches based on level-of-details (LoD) of the per vertex attributes.

Thus, the patch of the attribute video frame, such as the one depicted in FIG. 7, may be further split into two or more patches based on the LoDs of the blocks. The multiple patches may be rectangular, and they may comprise blocks from one or more LoD levels. There may be a patch for each LoD level, or one patch may comprise blocks from e.g. LoD levels 0 and 1 and another patch may comprise blocks from LoD levels 2 and 3. This also provides a possibility to have LoD-specific access to per vertex attributes, which enables progressive downloading for all components of V-DMC bitstream.

According to an embodiment, the packing of the per vertex attributes to an attribute video frame is carried out in the same order as per vertex displacement information in a displacement video frame, but in different patch position from a patch position in the displacement video frame.

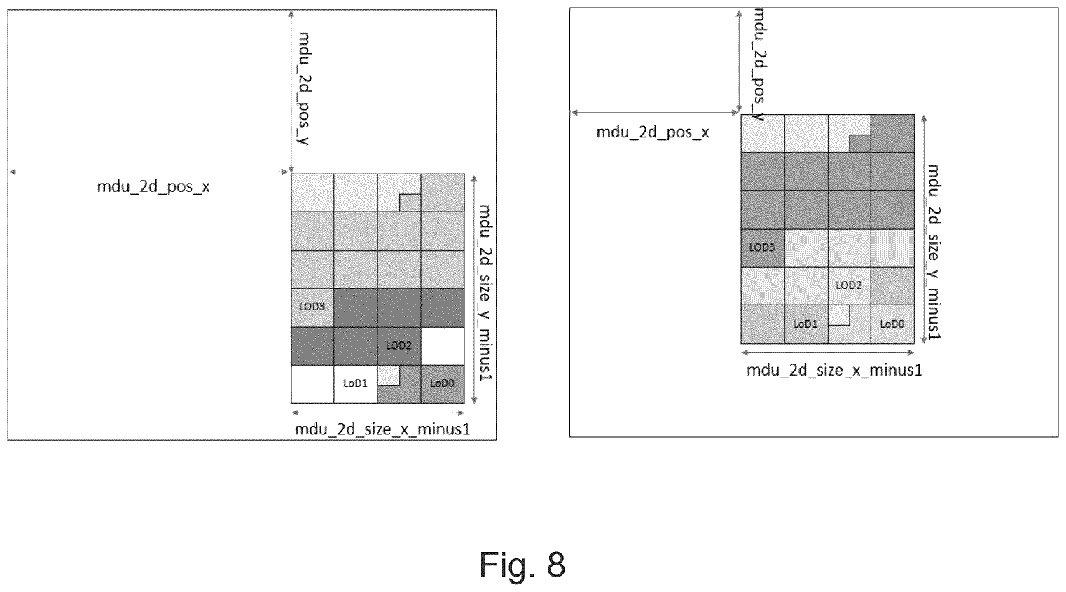

This is illustrated in FIG. 8, where the frame on the left again shows a displacement video frame similar to that of FIGS. 5 and 7, where the pixels of the patch comprise displacement information per vertex. The frame on the right shows an attribute video frame, where the pixels of the patch comprise attribute information per vertex. The size of the patch and the blocks representing the different LoDs are the same as in the displacement video frame. However, the location of the patch within the frame is adjusted to a different location.

According to an embodiment, a level-of-details (LoD) of the attribute video frame is different from the LoD in displacement video frame.

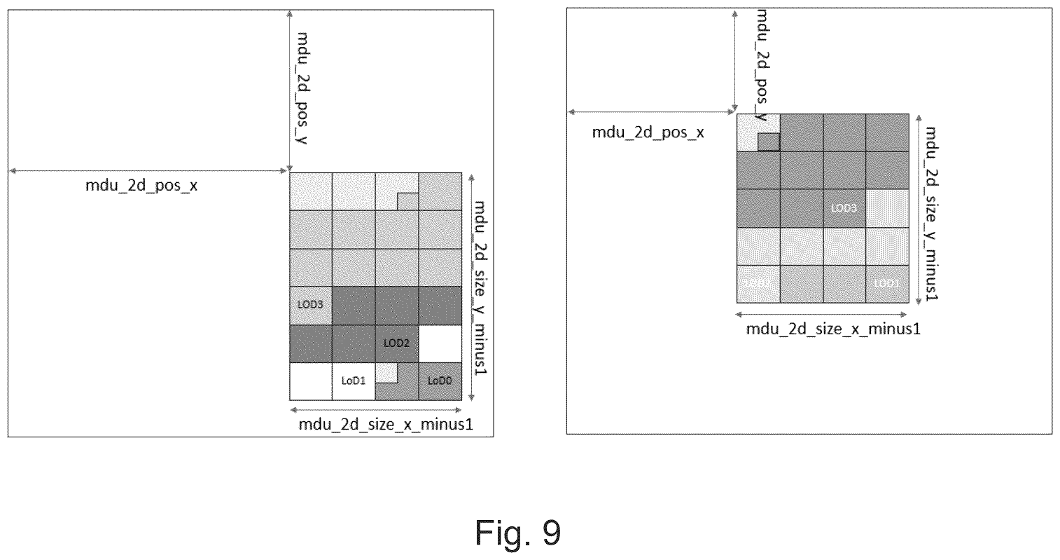

This is illustrated in FIG. 9, where the frame on the left again shows a displacement video frame similar to that of FIGS. 5, 7 and 8. The frame on the right shows an attribute video frame, where the pixels of the patch comprise attribute information per vertex, the blocks representing the different LoDs. In this example, the blocks having LoD0 are ignored, wherein the remaining blocks having LoD values 1-3 can be packed into a smaller patch. In this example, also the location of the patch within the frame is adjusted to a different location. The blocks having LoD0 may instead be delivered in the base mesh.

In the following, various embodiments relating to providing the one or more signaling elements in the bitstream to indicate an attribute packing method and the attribute type are disclosed.

It is noted that the attribute type, as used herein, refers to attribute type being either per face attributes or per vertex attributes, which is used as a basis for packing the attributes. In this context, attribute type does not refer to color, alpha, normal, reflections, etc.

It is further noted that the attribute packing method, as used herein, refers to either UV-based attribute packing or indexed attribute packing. The UV-based attribute packing is more appropriate for per face attributes, whereas the indexed attribute packing is more appropriate for per vertex attributes.

According to an embodiment, said one or more signaling elements in the bitstream provide a mapping of V3C attribute index to an attribute packing method.

Herein, for example V3C Parameter Set may be used to provide the mapping of V3C attribute index to attribute packing method.

According to an embodiment, the attribute packing method is based on UV coordinates, wherein said one or more signaling elements in the bitstream provide a mapping of the per face attributes to an attribute index of the simplified version of said at least one mesh frame.

Thus, when the packing method is the uv—(i.e texture coordinates) based attribute packing, the signaling in the bitstream provides a mapping of the per face attributes to the base mesh attribute index that indicates the uv coordinates for each of the per face attributes.

According to an embodiment, the attribute packing method is based on UV coordinates, wherein said one or more signaling elements in the bitstream provide a mapping of the per face attributes to patches in atlas.

Herein, when the packing method is uv-based attribute packing, the signaling in the bitstream further provides a mapping of the face vertex attributes to patches in atlas.

According to an embodiment, said one or more signaling elements in the bitstream provide an indication that the attribute packing method is index-based and the packing of the per vertex attributes to said at least one patch of the attribute video frame is carried out in the same order and patch position as per vertex displacement information in a displacement video frame.

Thus, when the packing method is indexed for per vertex attributes and the packing is aligned to the displacement video frame, no additional information is provided and patches to use can be implicitly deducted based on the alignment to the displacement video frame.

According to an embodiment, said one or more signaling elements in the bitstream provide an indication that the attribute packing method is index-based, wherein the packing of the per vertex attributes to an attribute video frame is carried out in the same order as per vertex displacement information in a displacement video frame, but in different patch position from a patch position in the displacement video frame, said one or more signaling elements in the bitstream provide a mapping of the per vertex attributes to patches in atlas.

Thus, when the packing method is indexed for per vertex attributes, but the packing is not aligned to the displacement video frame, the signaling in the bitstream further provides a mapping of the per vertex attributes to patches in atlas.

According to an embodiment, said one or more signaling elements in the bitstream provide an indication that the attribute packing method is index-based, wherein the level-of-details (LoD) of the attribute video frame is different from the LoD in displacement video frame, said one or more signaling elements in the bitstream provide information which attributes of the simplified version of said at least one mesh frame comprises corresponding per vertex attributes.

Herein, when the packing method is indexed for per vertex attributes, but the packing is not aligned to the displacement video frame, and further comprises information for a reduced set of LoD (such as only for LoD>0) of the attribute video frame, the signaling in the bitstream further provides information which attribute of base mesh contains the corresponding per vertex attributes.

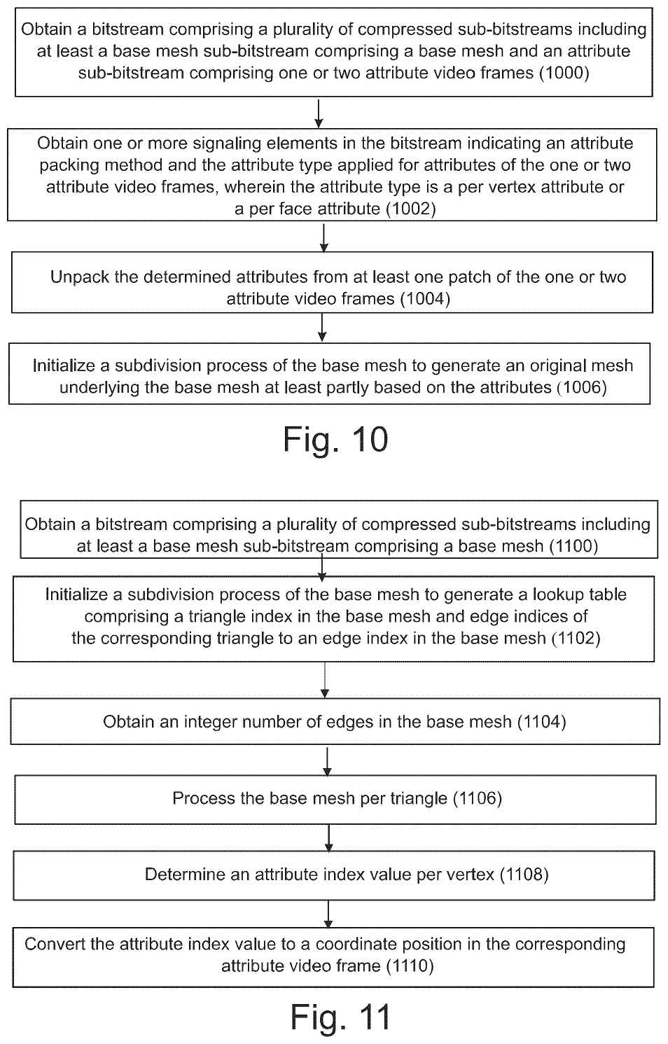

Another aspect relates to the operation of a decoding apparatus. FIG. 10 shows an example of a method comprising obtaining (1000) a bitstream comprising a plurality of compressed sub-bitstreams including at least a base mesh sub-bitstream comprising a base mesh and an attribute sub-bitstream comprising one or two attribute video frames; obtaining (1002) one or more signaling elements in the bitstream indicating an attribute packing method and the attribute type applied for attributes of the one or two attribute video frames, wherein the attribute type is a per vertex attribute or a per face attribute; unpacking (1004) the determined attributes from at least one patch of the one or two attribute video frame; and initializing (1006) a subdivision process of the base mesh to generate an original mesh underlying the base mesh at least partly based on the attributes.

Thus, the decoder obtains, such as receives the bitstream comprising at least a base mesh sub-bitstream comprising a base mesh and an attribute sub-bitstream comprising one or two attribute video frames. The attribute sub-bitstream may comprise one attribute video frame for per vertex attributes and/or one attribute video frame for per face attributes. The decoder also obtains, such as receives one or more signaling elements in the bitstream indicating an attribute packing method and the attribute type applied for attributes of the one or two attribute video frames, wherein the attribute type is a per vertex attribute or a per face attribute. The decoder unpacks the determined attributes from at least one patch of the one or two attribute video frames, thereby obtaining the relevant attributes without needing to deduce a lot of unnecessary data between the UV-mapped vertices later during the subdivision process of the base mesh.

It is noted that the decoding apparatus, as used herein, may refer to an apparatus comprising a rendering functionality, a.k.a. a renderer, which may also be referred to as a media player or viewer. The receiver may also be a client in client-server architecture.

One way to implement the above signaling embodiments is to provide the information in V3C Parameter Set. The signaling may be provided, for example, in a V-DMC extension of the V3C Parameter Set, for example as follows:

TABLE 5

| | Descriptor |
|---|---|
| vps_vdmc_extension ( ) { | |
| for( k=0; k<vps_atlas_count_minus1+1; k++ ){ | |
| j = vps_atlas_id[ k ] | |
| vps_ext_bmesh_data_substream_codec_id[ j ] | u(8) |
| vps_ext_bmesh_geometry_3d_bit_depth_minus1[ j ] | u(5) |
| vps_ext_bmesh_geometry_3d_msb_align_flag[ j ] | u(1) |
| vps_ext_bmesh_data_attribute_count[ j ] | u(8) |
| for( i = 0; i < vps_ext_bmesh_data_attribute_count[ j ]; i++ ) { | |
| vps_ext_bmesh_attribute_index[ j ][ i ] | u(7) |
| vps_ext_bmesh_attribute_bit_depth_minus1[ j ][ i ] | u(5) |
| vps_ext_bmesh_attribute_msb_align_flag[ j ][ i ] | u(1) |
| vps_ext_bmesh_attribute_type[ j ][ i ] | u(4) |
| } | |
| for( i = 0; i < ai_attribute_count[ j ]; i++ ) { | |
| vps_ext_attribute_frame_width[ j ][ i ] | ue(v) |
| vps_ext_attribute_frame_height[ j ][ i ] | ue(v) |
| vps_ext_attribute_packing_method[ j ][ i ] | u(3) |
| if(vps_ext_attribute_packing_method[ j ][ i ] == 0 ) | |
| vps_ext_bmesh_attribute_texcoord_index[ j ][ i ] | u(7) |
| if(vps_ext_attribute_packing_method[ j ][ i ] == 1 ) | |
| if(vps_ext_attribute_packing_method[ j ][ i ] == 2 ∥ | |
| vps_ext_attribute_packing_method[ j ][ i ] == 3) | |
| vps_ext_atlas_attribute_information_idx[ j ][ i ] | u(7) |
| if(vps_ext_attribute_packing_method[ j ][ i ] == 3 ) | |
| vps_ext_bmesh_attribute_index[ j ][ i ] | u(7) |
| } | |
| } | |
| } | |

In the above syntax, the following semantics may be used:

vps_ext_attribute_packing_method[j][i] indicates the packing method of the attributes to video frame of the Attribute Video Data unit with index i in for the atlas with atlas ID j.

vps_ext_attribute_packing_method[j][i] equal to 0 indicates that attributes are per face and can be access using uv coordinates that are signaled in base mesh.

vps_ext_attribute_packing_method[j][i] equal to 1 indicates that attributes are per vertex and can be access the same way as the displacement data and share patch information with displacement data.

vps_ext_attribute_packing_method[j][i] equal to 2 indicates that attributes are per vertex and can be access the same way as the displacement data but have their own patches in atlas bitstream.

vps_ext_attribute_packing_method[j][i] equal to 3 indicates that attributes are per vertex and can be access the same way as the displacement data but have their own patches in atlas bitstream and do not contain information for LoD 0 which is provided by base mesh bitstream.

vps_ext_bmesh_attribute_texcoord_index[j][i] indicates attribute index in base mesh that contains uv coordinates to access the attributes in video frame of the Attribute Video Data unit with index i in for the atlas with atlas ID j

vps_ext_atlas_attribute_information_idx[j][i] indicates attribute information index in atlas that contains patches related the Attribute Video Data unit with index i in for the atlas with atlas ID j.

The attribute information index may be linked, for example, to atlas sequence parameter set (ASPS) loop:

TABLE 6

| | |
|---|---|
| asve_num_attribute_video | u(7) |
| for(i=0; i< asve_num_attribute_video; i++){ | |
| asve_attribute_type_id[ i ] | u(4) |
| asve_attribute_frame_width[ i ] | ue(v) |
| asve_attribute_frame_height[ i ] | ue(v) |
| asve_attribute_subtexture_enabled_flag[ i ] | u(1) |
| } | |

The attribute information index may alternatively be linked, for example, to atlas frame parameter set (AFPS) loop:

TABLE 7

for( attrIdx=0; attrIdx< asve_num_attribute_video; attrIdx++ )
atlas_frame_attribute_tile_information( attrIdx )

Alternatively, signal attribute information ID (vps_ext_atlas_attribute_information_idx) may be signaled instead, together with ASPS/AFPS being linked to tiles/patches. This way a mapping between atlas level information to V3C level information is achieved.

vps_ext_bmesh_attribute_index[j][i] indicates attribute index in base mesh that contains attribute data for LoD0 of the Attribute Video Data unit with index i in for the atlas with atlas ID j.

According to an embodiment, the above signaling embodiment of the attribute packing method may be implemented by providing said information in atlas sequence parameter set, for example in the ASPS loop:

TABLE 8

| | |
|---|---|
| asve_num_attribute_video | u(7) |
| for(i=0; i< asve_num_attribute_video; i++){ | |
| asve_attribute_packing_method[ i ] | u(7) |
| asve_attribute_type_id[ i ] | u(4) |
| asve_attribute_frame_width[ i ] | ue(v) |
| asve_attribute_frame_height[ i ] | ue(v) |
| asve_attribute_subtexture_enabled_flag[ i ] | u(1) |
| } | |

Herein, the same semantics as used for vps_ext_attribute_packing_method above can be used for asve_attribute_packing_method, as well.

According to an embodiment, the method comprises providing at least one signaling element in the bitstream to assist extraction process from the video frame.

A second aspect relates to providing one or more signaling elements in a bitstream to assist an extraction process from the video frame and accessing the per vertex attributes in the indexed packing method.

One way of accessing the attribute values per vertex, in index packing method, is to perform similar operation as defined in ISO/IEC 23090-29, chap. 11.2.4 “Inverse image packing of transform coefficients for displacement video”. However, in many cases this approach is non-optimal as it requires to perform all the subdivision operation on all triangles to identify the position of attribute value for each vertex. As a result, the decoder needs to at least:
Initialize the subdivision process, which requires at least to loop over the base mesh vertex count twice; and
For each subdivision
   loop over the vertex count of the previous subdivision
   loop over the triangle count of the previous subdivision twice.

The second aspect, as presented herein, enables to access per vertex data in a manner that reduces complexity and is better optimized for a processor, such as a graphics processing unit (GPU), implementation. It is noted that the second aspect is applicable, besides for attribute data, but for displacement (geometry) data as well.

A method according to the second aspect can be implemented either independently or in combination with one or more of the above or below embodiments. The method according to the second aspect is shown in FIG. 11, where the method comprises obtaining (1100) a bitstream comprising a plurality of compressed sub-bitstreams including at least a base mesh sub-bitstream comprising a base mesh; initializing (1102) a subdivision process of the base mesh to generate a lookup table comprising a triangle index in the base mesh and edge indices of the corresponding triangle to an edge index in the base mesh; obtaining (1104) an integer number of edges in the base mesh; processing (1106) the base mesh per triangle; determining (1108) an attribute index value per vertex; and converting (1110) the attribute index value to a coordinate position in the corresponding attribute video frame.

Thus, first an initialization of subdivision process is performed to generate a lookup table of triangle index in the base mesh to edge indices of the corresponding triangle, i.e.

$$lookupTable [ tbmIdx ] [ etIdx ] = embIdx$$

ebmIdx—edge index in the base mesh, from 0 to edge count in the base mesh;
tbmIdx—triangle index in the base mesh, from 0 to triangles count in the base mesh;
etIdx—edge index in the triangle, from 0 to 2.

During the initialization process information on edgeCount value, i.e., the number of edges in the base mesh, is obtained, as well.

Based on the look up table and the edgeCount value, the processing of the base mesh may be carried out per triangle and an attribute index value per vertex may be determined, which later on may be converted to pixel x,y position in attribute video frame using information provided by atlas data.

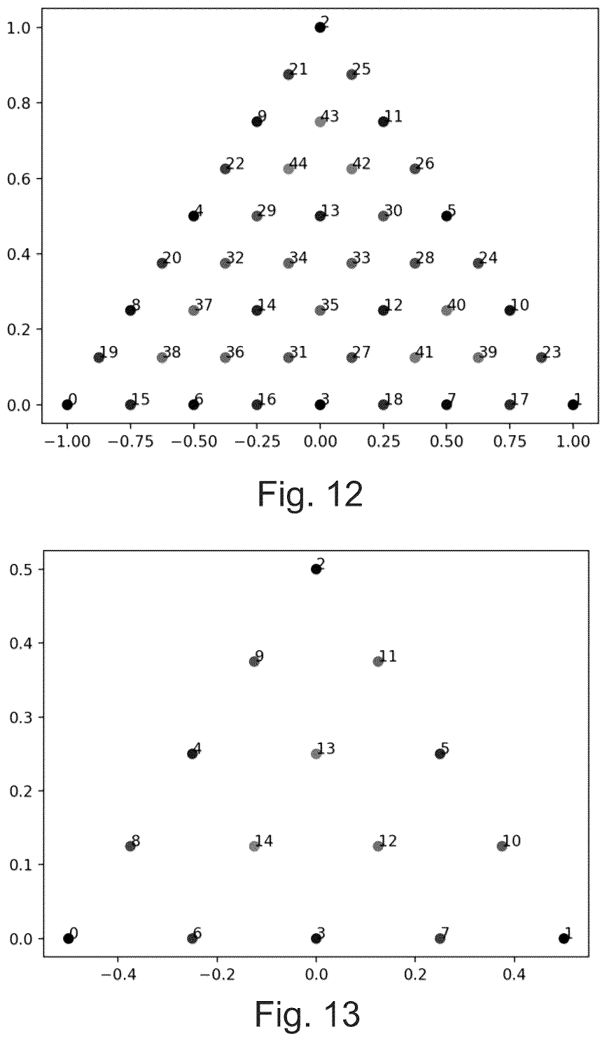

The second aspect may be illustrated by referring to an example of subdividing a base mesh as shown in FIGS. 12 and 13.

FIG. 12 shows a base mesh triangle subdivided 3 times. The base mesh triangle was generated by vertices 0, 1, 2.

Attribute index, aIdx, for a given vertex can be calculated as follows:
LoD0: (0, 1, 2 on Figure)

$$aIdx = vertex index$$

It is noted that in practical implementations the vertex index can be provided by the GPU pipeline. For example, OpenGL provides access to gl_VertexID in vertex shader, which can be propagated through the pipeline to tessellation evaluation shader.
LoD1: (3, 4, 5)

$$aIdx = LoD 0. vertexCount + lookupTable [ tbmIdx ] [ etIdx ]$$

Herein, LoD0.vertexCount is a value that is provided by atlas bitstream and does not have to be calculated.

It is noted that in practical implementations the edge index etIdx may be identified in the GPU pipeline, e.g., in OpenGL tessellation evaluation shader edge index may be determined based on gl_TessCoord values. Furthermore, the triangle index tbmIdx may be identified in the GPU pipeline, e.g., in OpenGL tessellation evaluation shader triangle index may be determined based on gl_PrimitiveID value, if the tessellation patch operates on 3 vertices.
LoD2 on the edge eIdx where aIdx[0] is always closer to the smaller vertex index in the base mesh

$$aId x [ 0 ] = LoD 1. vertexCount + lookupTable [ tbmIdx ] [ etIdx ]$$

$$aIdx [ 1 ] = LoD 1. vertexCount + lookupTable [ tbmIdx ] [ etIdx ] + 1$$

In the middle of the triangle, the attribute index is calculated based on the known patter that determines z, based on FIG. 13 showing the base mesh subdivided twice. Thus, when calculating aIdx for vertex 12, z is 0, for vertex 13, z is 1 and for vertex 14, z is 2.

$$aIdx = LoD 0. vertexCount + edgeCount * 3 + tbmIdx * 3 + z$$

Herein, the edgeCount is multiplied by 3, since each edge has 3 new vertices from LOD1 and LOD2. Also, the tbmIdx is multiplied by 3, since each previous triangle adds 3 vertices in the middle.
LoD3 on the edge etIdx where aIdx[0] is always closer to the smaller vertex index in the base mesh

$$a I d x [ 0 ] = L o D 0 12. vertexCount + lookupTable [ tbmIdx ] [ etIdx ] + 0$$

$$aIdx [ 1 ] = L o D 0 12. vertexCount + lookupTable [ tbmIdx ] [ etIdx ] + 1$$

$$aIdx [ 2 ] = L o D 0 12. vertexCount + lookupTable [ tbmIdx ] [ etIdx ] + 3$$

$$aIdx [ 3 ] = L o D 0 12. vertexCount + lookupTable [ tbmIdx ] [ etIdx ] + 2$$

Herein, LoD012 is cumulative amount of vertices in LoD 1 and LoD2 and that information is provided in the atlas bitstream.

In the middle, there is always a pattern form where z can be determined. Based on the determined z, the vertex in the triangle is processed as

$$aIdx = LoD 0. vertexCount + eCount * 7 + triangleIdx * 21 + z$$

Herein, the edgeCount is multiplied by 7, since each edge has 7 new vertices from LoD1, LoD2, and LoD3. Also, the tbmIdx is multiplied by 3, since each previous triangle adds 21 vertices in the middle.

Following this, the equations for the attribute index of a given vertex can be extrapolated to the next LoDs.

It is noted that a displacement index for a vertex can be determined in the same way as determining an attribute index for a vertex disclosed above.

The embodiments relating to the encoding aspects may be implemented in an apparatus comprising: means for obtaining at least one mesh frame; means for analyzing said at least one mesh frame to determine which types of attributes are available as per vertex attributes or per face attributes; means for generating a simplified version of said at least one mesh frame; means for packing the determined attributes into at least one patch of one or two attribute video frames based on the attribute type, wherein the attribute type is a per vertex attribute or a per face attribute; and means for providing one or more signaling elements in a bitstream to indicate an attribute packing method and the attribute type into a video frame.

According to an embodiment, the apparatus comprises means for providing at least one signaling element in the bitstream to assist extraction process from the video frame.

According to an embodiment, the packing of the per vertex attributes to an attribute video frame is carried out in the same order and patch position as per vertex displacement information in a displacement video frame.

According to an embodiment, the apparatus comprises means for splitting said at least one patch of the attribute video frame into multiple patches based on level-of-details (LoD) of the per vertex attributes.

According to an embodiment, the packing of the per vertex attributes to an attribute video frame is carried out in the same order as per vertex displacement information in a displacement video frame, but in different patch position from a patch position in the displacement video frame.

According to an embodiment, a level-of-details (LoD) of the attribute video frame is different from the LoD in displacement video frame.

According to an embodiment, said one or more signaling elements in the bitstream provide a mapping of V3C attribute index to an attribute packing method.

According to an embodiment, the attribute packing method is based on UV coordinates, wherein said one or more signaling elements in the bitstream provide a mapping of the per face attributes to an attribute index of the simplified version of said at least one mesh frame.

According to an embodiment, the attribute packing method is based on UV coordinates, wherein said one or more signaling elements in the bitstream provide a mapping of the per face attributes to patches in atlas.

According to an embodiment, said one or more signaling elements in the bitstream provide an indication that the attribute packing method is index-based.

The embodiments relating to the encoding aspects may likewise be implemented in an apparatus comprising at least one processor and at least one memory, said at least one memory stored with computer program code thereon, the at least one memory and the computer program code configured to, with the at least one processor, cause the apparatus at least to perform: obtain at least one mesh frame; analyze said at least one mesh frame to determine which types of attributes are available as per vertex attributes or per face attributes; generate a simplified version of said at least one mesh frame; pack the determined attributes into at least one patch of one or two attribute video frames based on the attribute type, wherein the attribute type is a per vertex attribute or a per face attribute; and provide one or more signaling elements in a bitstream to indicate an attribute packing method and the attribute type into a video frame.

According to an embodiment, the apparatus comprises code configured to cause the apparatus to provide at least one signaling element in the bitstream to assist extraction process from the video frame.

According to an embodiment, the packing of the per vertex attributes to an attribute video frame is carried out in the same order and patch position as per vertex displacement information in a displacement video frame.

According to an embodiment, the apparatus comprises code configured to cause the apparatus to split said at least one patch of the attribute video frame into multiple patches based on level-of-details (LoD) of the per vertex attributes.

According to an embodiment, the packing of the per vertex attributes to an attribute video frame is carried out in the same order as per vertex displacement information in a displacement video frame, but in different patch position from a patch position in the displacement video frame.

According to an embodiment, a level-of-details (LoD) of the attribute video frame is different from the LoD in displacement video frame.

According to an embodiment, said one or more signaling elements in the bitstream provide a mapping of V3C attribute index to an attribute packing method.

According to an embodiment, the attribute packing method is based on UV coordinates, wherein said one or more signaling elements in the bitstream provide a mapping of the per face attributes to an attribute index of the simplified version of said at least one mesh frame.

According to an embodiment, the attribute packing method is based on UV coordinates, wherein said one or more signaling elements in the bitstream provide a mapping of the per face attributes to patches in atlas.

According to an embodiment, said one or more signaling elements in the bitstream provide an indication that the attribute packing method is index-based.

The embodiments relating to the decoding aspects may be implemented in an apparatus comprising: means for obtaining a bitstream comprising a plurality of compressed sub-bitstreams including at least a base mesh sub-bitstream comprising a base mesh and an attribute sub-bitstream comprising one or two attribute video frames; means for obtaining one or more signaling elements in the bitstream indicating an attribute packing method and the attribute type applied for attributes of the one or two attribute video frames, wherein the attribute type is a per vertex attribute or a per face attribute; means for unpacking the determined attributes from at least one patch of the one or two attribute video frames; and means for initializing a subdivision process of the base mesh to generate an original mesh underlying the base mesh at least partly based on the attributes.

According to an embodiment, the apparatus comprises means for initializing a subdivision process of the base mesh to generate a lookup table comprising a triangle index in the base mesh and edge indices of the corresponding triangle to an edge index in the base mesh; means for obtaining an integer number of edges in the base mesh; means for processing the base mesh per triangle; and means for determining an attribute index value per vertex; and means for converting the attribute index value to a coordinate position in the corresponding attribute video frame.

The embodiments relating to the decoding aspects may likewise be implemented in an apparatus comprising at least one processor and at least one memory, said at least one memory stored with computer program code thereon, the at least one memory and the computer program code configured to, with the at least one processor, cause the apparatus at least to perform: obtain a bitstream comprising a plurality of compressed sub-bitstreams including at least a base mesh sub-bitstream comprising a base mesh and an attribute sub-bitstream comprising one or two attribute video frames; obtain one or more signaling elements in the bitstream indicating an attribute packing method and the attribute type applied for attributes of the one or two attribute video frames, wherein the attribute type is a per vertex attribute or a per face attribute; unpack the determined attributes from at least one patch of the one or two attribute video frames; and initialize a subdivision process of the base mesh to generate an original mesh underlying the base mesh at least partly based on the attributes.

According to an embodiment, the apparatus comprises code configured to cause the apparatus to initialize a subdivision process of the base mesh to generate a lookup table comprising a triangle index in the base mesh and edge indices of the corresponding triangle to an edge index in the base mesh; obtain an integer number of edges in the base mesh; process the base mesh per triangle; and determine an attribute index value per vertex, and; convert the attribute index value to a coordinate position in the corresponding attribute video frame.

Such apparatuses may comprise e.g. the functional units disclosed in any of the FIGS. 1a, 1b, 2a and 2b for implementing the embodiments.

In the above, some embodiments have been described with reference to encoding. It needs to be understood that said encoding may comprise one or more of the following: encoding source image data into a bitstream, encapsulating the encoded bitstream in a container file and/or in packet(s) or stream(s) of a communication protocol, and announcing or describing the bitstream in a content description, such as the Media Presentation Description (MPD) of ISO/IEC 23009-1 (known as MPEG-DASH) or the IETF Session Description Protocol (SDP). Similarly, some embodiments have been described with reference to decoding. It needs to be understood that said decoding may comprise one or more of the following: decoding image data from a bitstream, decapsulating the bitstream from a container file and/or from packet(s) or stream(s) of a communication protocol, and parsing a content description of the bitstream,

In the above, where the example embodiments have been described with reference to an encoder or an encoding method, it needs to be understood that the resulting bitstream and the decoder or the decoding method may have corresponding elements in them. Likewise, where the example embodiments have been described with reference to a decoder, it needs to be understood that the encoder may have structure and/or computer program for generating the bitstream to be decoded by the decoder.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. An apparatus comprising at least one processor and at least one memory, said at least one memory stored with computer program code thereon, the at least one memory and the computer program code configured to, with the at least one processor, cause the apparatus at least to perform:
obtaining at least one mesh frame;
analyzing said at least one mesh frame to determine which types of attributes are available as per vertex attributes or per face attributes;
generating a simplified version of said at least one mesh frame;
packing the determined attributes into at least one patch of one or two attribute video frames based on an attribute type, wherein the attribute type is a per vertex attribute or a per face attribute; and
providing one or more signaling elements in a bitstream to indicate an attribute packing method and the attribute type into a video frame.

2. The apparatus according to claim 1, wherein the apparatus is further caused to perform: providing at least one signaling element in the bitstream to assist extraction process from the video frame.

3. The apparatus according to claim 1, wherein the packing of the per vertex attributes to an attribute video frame is carried out in the same order and patch position as per vertex displacement information in a displacement video frame.

4. The apparatus according to claim 3, wherein the apparatus is further caused to perform: splitting said at least one patch of the attribute video frame into multiple patches based on level-of-details (LoD) of the per vertex attributes.

5. The apparatus according to claim 1, wherein the packing of the per vertex attributes to an attribute video frame is carried out in the same order as per vertex displacement information in a displacement video frame, but in different patch position from a patch position in the displacement video frame.

6. The apparatus according to claim 5, wherein a level-of-details (LoD) of the attribute video frame is different from the LoD in the displacement video frame.

7. The apparatus according to claim 1, wherein said one or more signaling elements in the bitstream provide a mapping of visual volumetric video-based coding (V3C) attribute index to the attribute packing method.

8. The apparatus according to claim 7, wherein the attribute packing method is based on UV coordinates, wherein said one or more signaling elements in the bitstream provide a mapping of the per face attributes to an attribute index of the simplified version of said at least one mesh frame.

9. The apparatus according to claim 7, wherein the attribute packing method is based on UV coordinates, wherein said one or more signaling elements in the bitstream provide a mapping of the per face attributes to patches in atlas.

10. The apparatus according to claim 1, wherein said one or more signaling elements in the bitstream provide an indication that the attribute packing method is index-based.

11. An apparatus comprising at least one processor and at least one memory, said at least one memory stored with computer program code thereon, the at least one memory and the computer program code configured to, with the at least one processor, cause the apparatus at least to perform:
obtaining a bitstream comprising a plurality of compressed sub-bitstreams including at least a base mesh sub-bitstream comprising a base mesh and an attribute sub-bitstream comprising one or two attribute video frames;
obtaining one or more signaling elements from the bitstream indicating an attribute packing method and an attribute type applied for attributes of the one or two attribute video frames, wherein the attribute type is a per vertex attribute or a per face attribute;
unpacking the determined attributes from at least one patch of the one or two attribute video frames; and
initializing a subdivision process of the base mesh to generate an original mesh underlying the base mesh at least partly based on the attributes.

12. The apparatus according to claim 11, wherein the apparatus is further caused to perform: initializing a subdivision process of the base mesh to generate a lookup table comprising a triangle index in the base mesh and edge indices of a corresponding triangle to an edge index in the base mesh;
obtaining an integer number of edges in the base mesh;
processing the base mesh per triangle;
determining an attribute index value per vertex; and
converting the attribute index value to a coordinate position in a corresponding attribute video frame.

13. A method comprising:
obtaining at least one mesh frame;
analyzing said at least one mesh frame to determine which types of attributes are available as per vertex attributes or per face attributes;
generating a simplified version of said at least one mesh frame;
packing the determined attributes into at least one patch of one or two attribute video frames based on an attribute type, wherein the attribute type is a per vertex attribute or a per face attribute; and
providing one or more signaling elements in a bitstream to indicate an attribute packing method and the attribute type into a video frame.

14. The method according to claim 13, further comprising: providing at least one signaling element in the bitstream to assist extraction process from the video frame.

15. The method according to claim 13, wherein the packing of the per vertex attributes to an attribute video frame is carried out in the same order and patch position as per vertex displacement information in a displacement video frame.

16. The method according to claim 15, further comprising: splitting said at least one patch of the attribute video frame into multiple patches based on level-of-details (LoD) of the per vertex attributes.

17. The method according to claim 13, wherein the packing of the per vertex attributes to an attribute video frame is carried out in the same order as per vertex displacement information in a displacement video frame, but in different patch position from a patch position in the displacement video frame.

18. The method according to claim 17, wherein a level-of-details (LoD) of the attribute video frame is different from the LoD in the displacement video frame.

19. The method according to claim 13, wherein said one or more signaling elements in the bitstream provide a mapping of V3C attribute index to the attribute packing method.

20. A method comprising:
obtaining a bitstream comprising a plurality of compressed sub-bitstreams including at least a base mesh sub-bitstream comprising a base mesh and an attribute sub-bitstream comprising one or two attribute video frames;
obtaining one or more signaling elements in the bitstream indicating an attribute packing method and an attribute type applied for attributes of the one or two attribute video frames, wherein the attribute type is a per vertex attribute or a per face attribute;
unpacking the determined attributes from at least one patch of the one or two attribute video frames; and
initializing a subdivision process of the base mesh to generate an original mesh underlying the base mesh at least partly based on the attributes.
